(19) United States
(12) Patent Application Publication
(10) Pub. No.: US 2010/0251233 A1
(43) Pub. Date: Sep. 30, 2010

(54) EMBEDDED COMPUTING SYSTEM USER INTERFACE EMULATED ON A SEPARATE COMPUTING DEVICE

(75) Inventors: Joseph Steven Majewski, Strongsville, OH (US); Bernard T. Geary, Fairlawn, OH (US)

Correspondence Address: HONEYWELL/CST;Patent Services, 101 Columbia Road, P.O. Box 2245, Morristown, NJ, 07962-2245, US

(73) Assignee: Honeywell International Inc., Morristown, NJ (US)

(21) Appl. No.: 12/411,080

(22) Filed: Mar. 25, 2009

(51) Int. Cl. G06F 9/455; G06F 3/048

(52) U.S. Cl. 718/1; 715/762

(57) ABSTRACT

A system for standalone usage of an embedded computing system user interface on a separate heterogeneous computing device. The system may run the same binary software image as the embedded computing device on a PC platform. Because it is virtually the same exact software image as that which is on the device, the PC-hosted version effectively has full fidelity with the device version. Its user interface is virtually identical in appearance and has full navigation and a richer subset of functionality than would be possible with a simulator. Also, it is not necessary to maintain separate simulation and device software since both environments may use the same binary image.

Related patent applications include U.S. patent application Ser. No. ______, Attorney Docket No. H0021716-1161.1398101, filed Mar. 25, 2009, entitled “MECHANISM FOR INTERFACING A DISPLAY SCREEN OF ANOTHER TECHNOLOGY WITH A COMPUTING PLATFORM”; U.S. patent application Ser. No. ______, Attorney Docket No. H0021919-1161.1399101, filed Mar. 25, 2009, entitled, “A SMALL SCREEN DISPLAY WITH A DATA FILTERING AND SORTING USER INTERFACE”; U.S. patent application Ser. No. ______, Attorney Docket No. H0022766-1161.1417101, filed Mar. 25, 2009, entitled “A SYSTEM FOR DEFINING A USER INTERFACE OF A REMOTE DISPLAY DEVICE”; U.S. patent application Ser. No. ______, Attorney Docket No. H0022777-1161.1418101, filed Mar. 25, 2009, entitled “AN APPROACH FOR ADVANCED USER NAVIGATION”; U.S. patent application Ser. No. ______, Attorney Docket No. H0022474-1161.1419101, filed Mar. 25, 2009, entitled “AN AUTOMATIC CONFIGURATOR OF DISPLAY OBJECTS”; all of which are hereby incorporated by reference.

### BACKGROUND

The invention pertains to user interfaces and particularly to simulation of user interfaces.

### SUMMARY

The invention is an approach for standalone usage of an embedded computing system user interface on a separate heterogeneous computing device.

### BRIEF DESCRIPTION OF THE DRAWING

FIG. 1 is a diagram of a device operating system;

FIG. 2 is a diagram showing a PC operating system with an emulator;

FIG. 3 shows an embedded display application executing in a native embedded device; and

FIG. 4 shows an embedded display application running on a PC using a software emulator.

### DESCRIPTION

Viewing and interacting with the user interface of an embedded computing device generally requires a physical presence of the device. For purposes of sales demonstrations, product testing and other scenarios, it may be impracticable, inconvenient or impossible to use the actual device. For example, when demonstrating the device to a large group of people it is desirable to have the capability to project images on a large screen for all to see. This problem has been addressed in the past in different ways, most often by creating a PC-based simulation of the embedded device's user interface. This solution may have several drawbacks. First, two different sets of software must be created and maintained—one for the actual device and one for the PC-based simulator. Second, the PC-based simulator software typically uses different user interface technology resulting in appearance differences between it and the device. Third, the simulator software often does not present the full complement of navigation and functionality as the original device.

The present invention addresses the problem described above by running the same binary software image as the embedded computing device on a PC platform. Because it is virtually the same exact software image as that which is on the device, the PC-hosted version effectively has full fidelity with the device version. Its user interface is virtually identical in appearance and has full navigation and a richer subset of functionality than would be possible with a simulator. Also, it is not necessary to maintain separate simulation and device software since both environments use the same binary image.

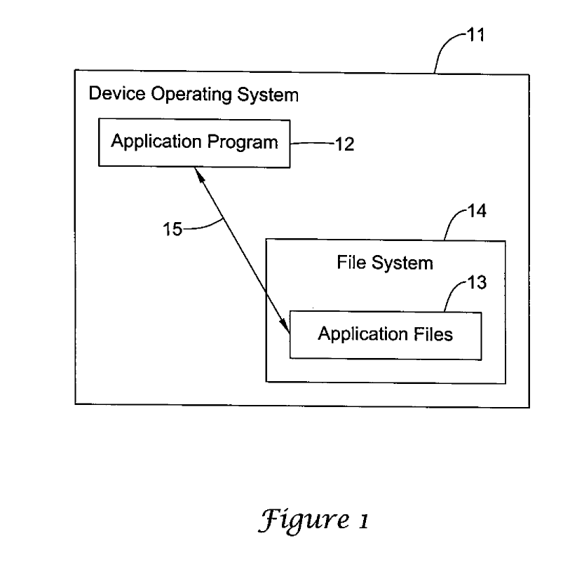

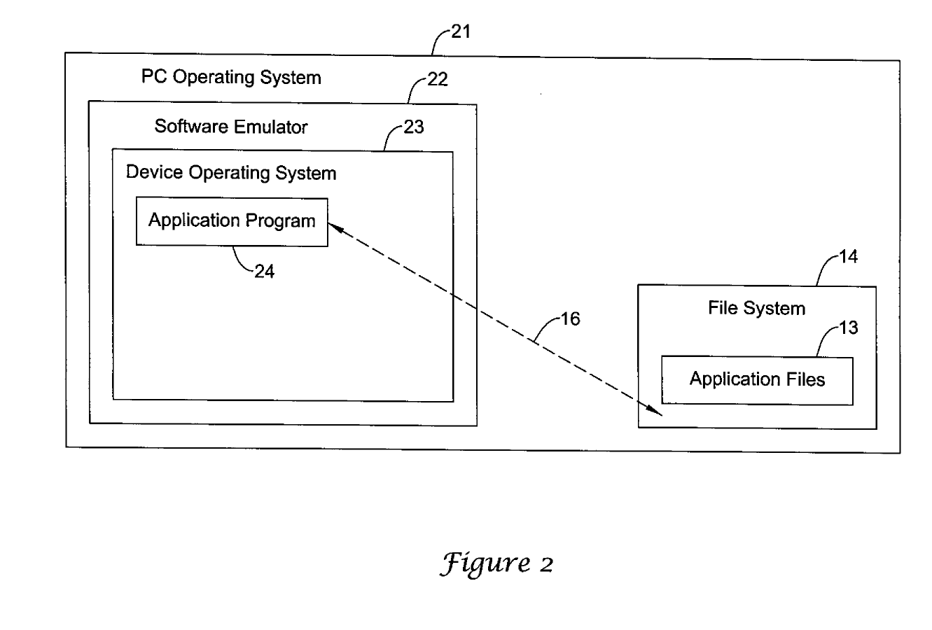

The block diagrams of FIGS. 1 and 2 illustrate a concept of running embedded computing system software natively in an embedded computing device 11 and non-natively with the capabilities of customization of, for example a user interface, in a PC operating system 21 environment using a software emulator 22. FIG. 1 is a diagram of the native device operating system 11. Device operating system 11 may have an application program 12 having a connection 15 with application files 13 of a file system 14.

FIG. 2 is a diagram showing a PC operating system 21. Operating system 21 may have the software emulator 22 for emulating a device operating system 23 like system 11. System 21 may have an application program 24 which is like program 12 of system 11. Application program 24 may run with the same code as that in Application 12. Application program 24 may have a connection 16 with the application files 13 of file system 14. The file system 14 may be in the PC operating system 21 or the device operating system 11 with a respective connection with PC operating system 21. The file system 14 may be mapped by emulator 22 for use by the application program 24. When bringing file system 14 onto the PC operating system 21, the device operating system 11 is not necessarily needed for use, demonstration and customization of, for instance, the user interface of system 11. Thus, it appears more convenient to bring on the file system and leave the system 11 hardware behind. Further, using the PC operating system 21, one may use the display of system 21 for viewing, demonstrating, customizing and the like since the screen of system 11 may be rather small during activity, especially while dealing with a customer or potential customer relative to desired design, features and so forth. The system 21 may have portability, such as in the form of a laptop. The display of the laptop or a projector with a large screen connected to the laptop makes it convenient to show screens easy for others to see.

Various descriptions of the components may be noted. The device operating system 11 may be an embedded computer operating system such as Microsoft's Windows CE Embedded. The application program 12 may be an embedded software application including user interface functionality. The application files 13 may be all file-based resources used by the application program including graphics images and XML configuration files. The filesystem 14 may be a computing file system of the type generally available under virtually all computer operating systems and be capable of storing data as named logical files. The software emulator 22 may be a PC-based program which can emulate another non-native microprocessor instruction set and support cross execution of binary application and operating system images. The emulator 22 needs to have the capability of mapping PC (host) operating system 21 elements such as file system 14 between the emulator 22 and the host for sharing of files. An example of a software emulator 22 is Microsoft's Windows CE Device Emulator which may cross-execute an ARMV4I instruction set on an 80×86 PC. This product may support execution of Windows CE operating system images and associated application programs, and provide for mapping of the host file system 14 to the emulator 22 for file sharing.

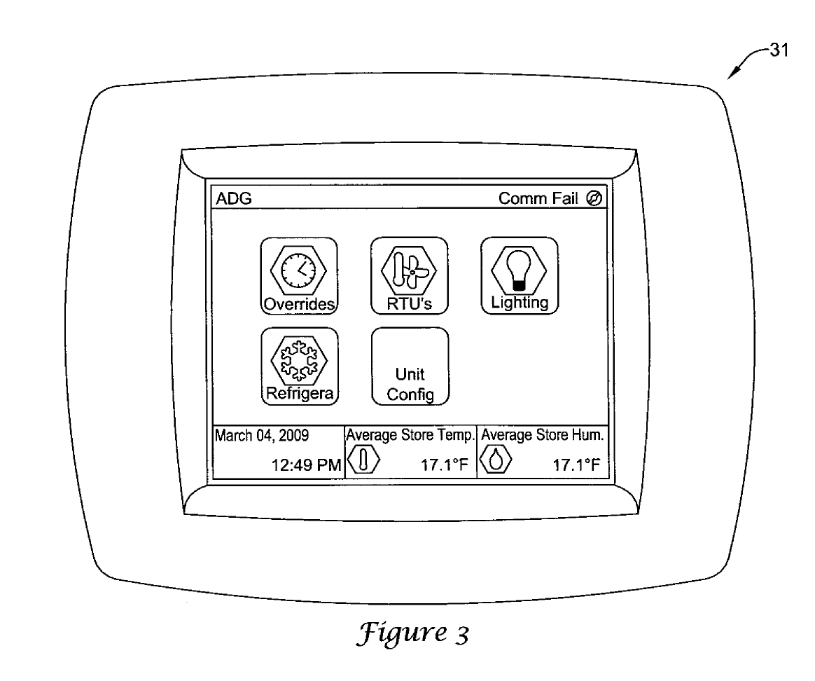

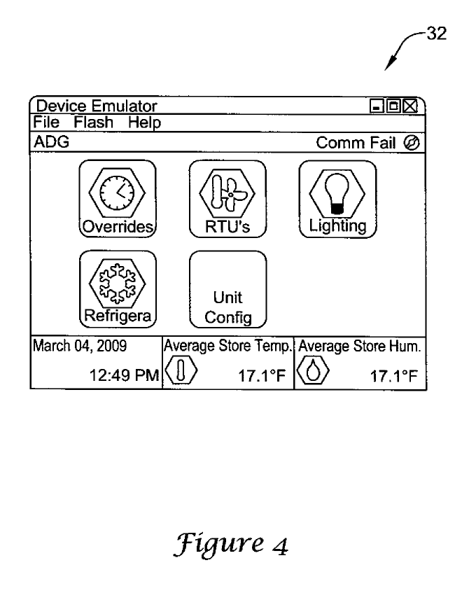

FIGS. 3 and 4 are screen captures showing the embedded display application running natively on the target device and in a PC-based software emulator, respectively. Specifically, FIG. 3 shows an embedded display 31 application executing in a native embedded device 11, and FIG. 4 shows an embedded display 32 application running on a PC operating system 21 using a software simulator or emulator 22. The embedded software application is the same between the embedded device and the PC. The reference implementation uses the Windows CE operating system both on the embedded device 11 and the PC 21, and the Microsoft Device Emulator 22 program is used to execute the Windows CE operating system on the PC 21 which in turn runs the embedded display application. On the target device, the Windows CE operating system executes natively and runs the embedded display application. The graphical images on both platforms are *.PNG and *.JPG graphics files. Both platforms also use the same configuration file for the display application. This configuration file is an XML formatted file containing metadata describing the screens, navigation and screen content (i.e., buttons, text, images).

The present invention may include the following background assumptions and prerequisites. First, the embedded device may use a computer operating system 11, for example, Microsoft's Windows CE™. Second, the PC-based software emulator 22 may exist for the embedded device's target processor and the embedded device's operating system, for example, Microsoft's Windows CE Device Emulator for the ARMV4I instruction set. Third, the software emulator 22 in the second item above has the capability to map to the file system 14 of the PC 21 for sharing of files between the emulator and the PC. The emulator 22 should also provide graphics display and user interaction through at minimum a pointing device such as a mouse or touchpad.

One version of the invention may consist of the following elements. First, one element may be an operating system image that would execute in the PC-based software emulator 22. It would be ideally very similar to the embedded device's operating system 11 but without support for device-side peripherals not available on a PC. It should have the same pixel resolution and color depth as the embedded device's display for fullest fidelity of rendering. The operating system image would ideally execute the application software image for the embedded device upon completing its initialization and startup sequence within the emulator 22.

Second, another element may be a shared operating system file folder accessible by both the software emulator 22 and the PC 21. This shared file folder would contain the operating system image, the application software and any files needed by the application software. Third, still another element may be application software (same as device application software).

In order to maximize the functionality available on the PC-based emulation of the device application software, it is desirable that the application software be capable of rendering its user interface and carrying out its user interface navigation in a manner which is portable or virtually identical in the two environments. The application software should not rely solely on device-specific definitions. Instead, it should use abstracted data structures and operating system calls which will operate without modification in either environment. In cases where this is unavoidable such the primary storage device name (i.e., “NandFlash” vs “C:\”), the application software will have the capability to determine at runtime which environment it is executing in and make the appropriate abstraction choices.

The following describes a reference implementation of the invention. It describes one way to realize the invention but should not be construed as the only method of implementation. The reference implementation of the invention may consist of the following items. First, there may be the Microsoft Windows CE Device Emulator software program. This program may execute a specified Windows CE image, a so-called NK.BIN file.

Second, there may be a specially constructed Windows CE image (NK.BIN) for execution within Device Emulator. Its purpose is to provide a nearly identical operating system image to the actual device's Windows CE image. It is built using Microsoft's Platform Builder tool for Windows CE. Upon completion of its startup, the image is programmed to launch the application software.

Third, there may be a Windows™ “batch” command file that runs the Device Emulator program with the NK.BIN file in second item above. In addition to launching the Windows CE operating system image, it also sets the display resolution and color depth to match the device's settings and creates a shared file folder between the emulator 22 and the PC 21 so that files from the PC's file system may be used.

Fourth, there may be the application software binary image. The application software has been designed so that the user interface definition including screens, buttons, navigation flow and other elements are contained within a single XML-format file called layout.xml. Additionally, the application software may make use of images such as GIF, JPG, PNG and BMP format files to assign graphics to buttons and other screen elements. Layout.xml and the optional graphics files reside in the shared file folder used by the emulator. A person using the invention may therefore update and modify the device application's user interface by simply copying new sets of files to the shared folder. The application software determines whether it is running on an embedded device or in emulation mode and makes appropriate modifications to its behavior. For example, device-specific items such as communications drivers and LCD backlight control are not started or are disabled in emulation mode.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. A system having an embedded computing system interface on a separate computing device, comprising:
a first operating system;
an emulator hosted by the first operating system and for emulating a second operating system of a building automation system; and
wherein an application program is in the second operating system.

2. The system of claim 1, further comprising a file system of the device operating system.

3. The system of claim 2, wherein the file system is mapped by the emulator for use in an application program of the first operating system.

4. The system of claim 3, wherein the file system comprises application files.

5. The system of claim 4, wherein the file system can be run directly on the first operating system.

6. The system of claim 5, wherein images of the second operating system are available on a display of the first operating system.

7. The system of claim 6, wherein:
the second operating system comprises a user interface; and
the user interface can be modified on the first operating system.

8. The system of claim 7, wherein:
the user interface comprises screens for a user; and
the screens are presentable on a display of the first operating system.

9. The system of claim 8, wherein the user interface can be customized with the first operating system.

10. A method for using a computing system interface on another computing system, comprising:
providing a first operating system having a first application program and a file system;
providing a second operating system;
placing an emulator into the second operating system, for providing an emulated first operating system; and
placing a second application program into the emulated first operating system; and
wherein:
the first and second application programs are in the same code; and
the first operating system of for a building control system.

11. The method of claim 10, further comprising connecting the second operating system to the file system of the first operating system.

12. The method of claim 10, further comprising:
placing a copy of the file system into the second operating system; and
connecting the copy of the file system to the second application program.

13. The method of claim 12, wherein the copy of the file system is mapped for use by the second application program.

14. The method of claim 13, wherein:
the first operating system comprises a user interface; and
the user interface can be modified by the second operating system via the second application program and the file system.

15. A mechanism using a computing system interface on another computing system, comprising:
a first operating system having a first application program and a file system;
a second operating system;
an emulator situated in the second operating system, for providing an emulated first operating system; and
a second application program situated in the emulated first operating system; and
wherein the first operating system is for a building automation system.

16. The mechanism of claim 15, wherein the second operating system is connected to the file system of the first operating system.

17. The mechanism of claim 15, further comprising:
a copy of the file system placed in the second operating system; and
wherein the copy of the file system is connected to the second application program.

18. The mechanism of claim 15, wherein the first and second application programs are in the same code.

19. The mechanism of claim 17, wherein the copy of the file system is mapped for use by the second application program.

20. The mechanism of claim 19, wherein:
the first operating system comprises a user interface; and
the user interface can be modified by the second operating system via the second application program and the file system.
